(19) United States
(12) Patent Application Publication
(10) Pub. No.: US 2008/0258361 A1
(43) Pub. Date: Oct. 23, 2008

(54) SUSPENSION SPRING MOUNT

(76) Inventors: Xinyu Wen, Shelby Township, MI (US); Rajesh Somnay, Troy, MI (US); Tomaz Dopico Varela, Shelby Township, MI (US); James Trotter, Auburn Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/061,690

(22) Filed: Apr. 3, 2008

Related U.S. Application Data
(60) Provisional application No. 60/912,504, filed on Apr. 18, 2007.

(51) Int. Cl. B60G 11/00

(52) U.S. Cl. 267/52

(57) ABSTRACT

A spring is to be supported on an axle with a housing. The housing surrounds a portion of the spring and has a housing inner portion positioned between first and second housing end portions. A lining secures the spring to the housing. A portion of the lining at the first and second housing end portions is thicker than a portion of the lining at the housing inner portion.

### RELATED APPLICATIONS

This application claims priority to U.S. Provisional Application No. 60/912,504 filed on Apr. 18, 2007.

### TECHNICAL FIELD

This invention generally relates to mounting a spring within a suspension system, and more specifically relates to a housing and spring mount assembly for a vehicle suspension.

### BACKGROUND OF THE INVENTION

Suspension systems use springs to provide desired ride control characteristics. In one known configuration, the springs extend in a longitudinal direction along a length of a vehicle and include one end that is connected to a vehicle frame or chassis member, a center portion that is supported on an axle, and an opposite end that is connected to the vehicle frame or chassis member. As known, the springs move and flex in response to road load and braking load inputs.

Spring mounts are used to secure the springs to the axle to permit movement of the spring between biased and unbiased positions. The springs can be made from different types of material. For example, some suspension systems utilize springs that are made from a composite material. Mounting composite springs within a suspension system presents certain challenges. In one known configuration, a metal housing surrounds a portion of the composite spring. The housing is supported on an upper surface of an axle beam such that the spring can be secured to the axle. Elastomer linings sandwich the spring within the bracket. The linings are adhesively secured to the housing and the spring.

An example of a prior art spring mount 10 is shown in FIG. 1. The prior art spring mount 10 includes an upper lining 14 bonded to an upper housing 16 and a lower lining 18 bonded to a lower housing 20. The upper 16 and lower 20 housings cooperate to form a housing assembly 22 that surrounds a composite spring 26. The upper lining 14 and the lower lining 18 are bonded to the composite spring 26 such that the spring 26 is secured to the housing assembly 22. The thickness of the upper lining 14 and the lower lining 18 may vary according to the contour of the spring 26 within the housing assembly 22. The upper lining 14 covers an entire upper portion of the spring 26 and fills the entire space between an upper surface of the spring 26 and an inner surface of the upper housing 16 located above the spring 26. The lower lining 18 covers an entire lower portion of the spring 26 and fills the entire space between a lower surface of the spring 26 and an inner surface of the housing assembly 22 located below the spring 26. As such, the entire length of the spring 26 located within the housing assembly 22 is bonded to both the upper lining 14 and the lower lining 18, and the upper lining 14 and lower lining 18 are bonded to the housing assembly 22. This mount interface secures the spring 26 relative to the housing assembly 22.

This method of securing a composite spring within a suspension system has disadvantages, especially under certain brake load applications. For example, the spring is subjected to high compression loads from a windup bumper during heavy brake load applications. Under this condition, composite springs experience a unique shear failure mode which limits the spring's ability to react to high compression loads from the windup bumper. The use of the elastomer linings allows a certain degree of deflection within the bracket; however, as brake regulations become stricter, i.e. as required stopping distances become shorter, the shear failure mode becomes even more important.

Thus, there is a need for a composite spring mount interface that reduces shear stresses in the spring.

### SUMMARY OF THE INVENTION

A spring is surrounded by a housing. The housing has a housing inner portion positioned between first and second housing end portions. A lining secures the spring to the housing. A portion of the lining at the first and second housing end portions is thicker than a portion of the lining at the housing inner portion.

In one example, the spring is made from a composite material and the lining is made from an elastomeric material.

In one example, the lining is comprised by a plurality of discrete lining portions. A first lining portion is axially spaced apart from a second lining portion such that there is a longitudinally extending clearance gap between the first and second lining portions. The clearance gap is located within the housing inner portion.

In one example, the housing is comprised of an upper housing portion and a lower housing portion that cooperate to surround the spring. The upper housing portion surrounds an upper side and opposing lateral side edges of the spring, while the lower housing portion surrounds the lower side of the spring. The lining does not fill the entire inner space defined between the spring and the upper and lower housing portions, such that clearance gaps are formed within the housing inner portion. One clearance gap is formed in the housing inner portion between the upper housing portion and the spring and another clearance gap is formed in the housing inner portion between the lower housing portion and the spring.

In one example, the upper housing portion includes an extension that extends longitudinally outward from one of the first and second housing end portions. The extension cooperates with a bumper component to provide a wind-up stop. In one example, the extension has a C-shape cross-section.

### BRIEF DESCRIPTION OF THE DRAWINGS

These and other features of the present invention can be best understood from the following specification and drawings, the following of which is a brief description.

FIG. 1 illustrates a prior art arrangement for mounting a spring.

FIG. 2A illustrates an arrangement for mounting a spring according to one example lining configuration.

FIG. 2B illustrates another example of a lining configuration.

FIG. 3 illustrates a cross-sectional view of the arrangement of FIG. 2A.

FIG. 4 illustrates another embodiment within a vehicle suspension system.

FIG. 5 illustrates another example arrangement of a lining configuration.

FIG. 6 illustrates a cross-sectional view of the arrangement of FIG. 5.

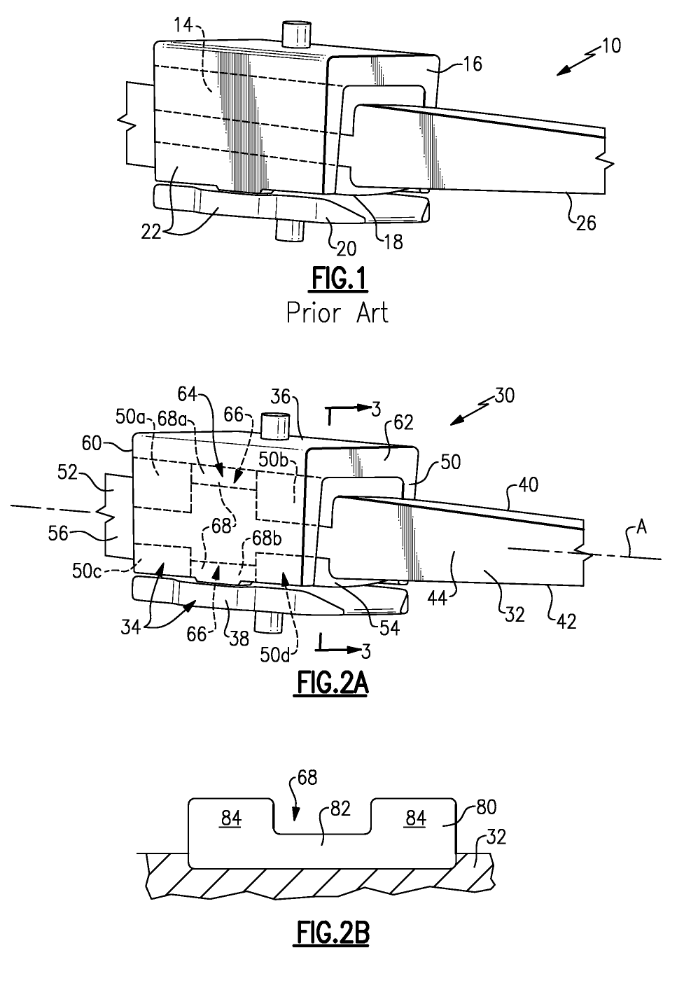

### DETAILED DESCRIPTION OF THE PREFERRED EMBODIMENT

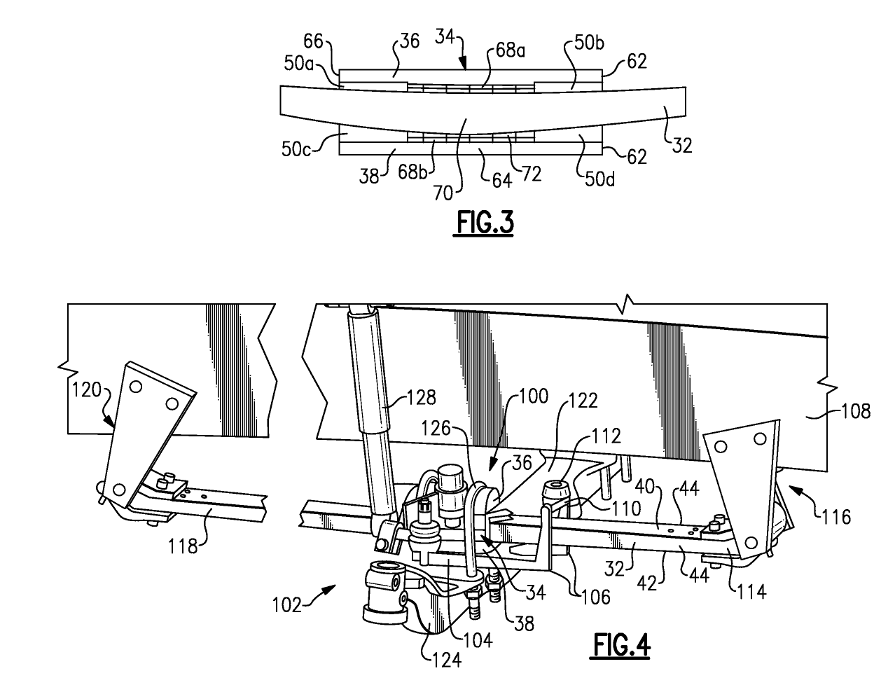

A spring mounting arrangement 30 according to one example includes a spring 32 housed within a housing assembly 34 as shown in FIG. 2A. The housing assembly 34 includes an upper housing portion 36 and a lower housing portion 38 that cooperate to surround the spring 32. Although shown as having similar lengths, the length of the upper housing portion 36 relative to the lower housing portion 38 may vary.

The spring 32 is shaped to have a rectangular cross-section and has an upper surface 40, a lower surface 42, and opposing lateral side edges 44. The spring 32 defines a longitudinal axis A that extends in a direction corresponding to a longitudinal length of a vehicle. The upper housing portion 36 is C-shaped such that the upper housing portion 36 surrounds the upper surface 40 and opposing lateral side edges 44. The lower housing portion 38 surrounds or covers the lower surface 42. The upper 36 and lower 38 housing portions cooperate to completely surround a central portion of the spring 32.

An upper lining 50 secures an upper portion 52 of the spring 32 to the upper housing portion 36. A lower lining 54 secures a lower portion 56 of the spring 32 to the lower housing portion 38. In one example, the housing assembly 34 secures and surrounds a greater longitudinal length of the spring 32 than prior art housing configurations.

In this example, the upper lining 50 and the lower lining 54 are adhesively bonded to the housing assembly 34 and the spring 32. The housing assembly 34 includes a first end 60 and a second end 62 that is longitudinally spaced from the first end 60. Between the first 60 and second 62 ends is a housing inner portion 64 that corresponds generally to a mid or central portion of the housing assembly 34.

The upper lining 50 and the lower lining 54 include lining portions that are secured to the spring 32 near the each of the first 60 and second 62 ends of the housing. The lining portions of the upper 50 and lower 54 linings are configured to fill space between upper and lower surfaces of the spring 32 at the first 60 and second 62 ends of the housing assembly 34. An inner cavity 66 defined by the housing inner portion 64 does not include any lining material, or optionally includes very little lining compared to the amount of lining at the first 60 and second 62 ends. In either configuration, a clearance gap 68 is formed within the housing inner portion 64.

In one example, the upper 50 and lower 54 linings are elastomeric linings and can be made from the same or different materials. In one example, the upper lining 50 can be made as a natural rubber lining while the lower lining 54 can comprise a polyurethane lining.

In one example, the spring 32 is a composite spring formed from an epoxy resin material and reinforcing fibers, such as glass fibers. Other suitable composite materials could also be used. The housing assembly 34 is typically formed from a metal, such as aluminum; however, other suitable materials could also be sued. The upper 50 and lower 54 linings protect the spring 32 from wear due to contact with the housing assembly 34. Loading the spring 32 moves the spring 32 between biased and unbiased positions. Loading occurs in response to inputs such as brake torque loads, for example.

In the example shown in FIG. 2A, the upper lining 50 is comprised of a first lining portion 50a and a second lining portion 50b that are longitudinally separated from each other by an upper clearance gap 68a. The lower lining 54 is comprised of a first lining portion 54a and a second lining portion 54b that are longitudinally separated from each other by a lower clearance gap 68b. Thus, the lining that secures the spring 32 to the housing assembly 34 is comprised of a plurality of discrete lining portions that are separated from each other. In the example shown, a longitudinal length of the gaps 68a, 68b is greater than a longitudinal length of the lengths of the discrete lining portions.

Such sectioning of the lining causes the reaction forces from the upper 50 and lower 54 linings to the spring 32 to be redistributed towards the first 60 and second 62 ends of the housing assembly 34. As shown in the cross-sectional view of FIG. 3, a twisting load on the spring 32 moves a center portion 70 of the spring 32 toward an interior wall 72 of the housing assembly 34. These types of loads often result from windup torques on the spring 32. Removing the upper 50 and lower 54 linings from this area generates reaction forces near the first 60 and second 62 ends of the housing assembly 34. These reaction forces have a larger longitudinal offset, and thus a bigger moment arm, when contributing to the total reaction torque near the housing assembly 34. As a result, these forces are generally of lower magnitude than prior art configurations, which results in less shear force with the spring 32 when flexing. In other words, the maximum shear forces previously experienced by the spring with prior designs are significantly decreased with the present configuration.

Thus, the example shown in FIG. 2A distributes loads more effectively across the spring 32 within the housing assembly 34 and lessens the load concentrations within the spring 32. In prior art arrangements, the center portion 70 of the spring 32 would have to withstand higher compressive loads because of limited clearances within the housing assembly 34. That is, moving the spring 32 would cause the spring 32 to compress associated linings within housing inner portion 64.

Another example embodiment is shown in FIG. 2B. In this example, an upper lining 80 extends through the housing inner portion 64 but includes a center portion 82 that is significantly reduced in thickness compared to end portions 84 of the upper lining 80. A lower lining portion (not shown) would be similarly configured. Reducing the thickness at the housing inner portion 64 functions similarly to removing the upper 50 and lower 54 linings entirely from the housing inner portion 64. The center portion 82 of the lining would not provide significant amount of reaction forces compared to the thicker lining end portions 84. Such an arrangement provides for movement of the spring 32 while protecting the spring 32 from damage due to contact with the housing assembly 34.

FIG. 4 illustrates an example of a spring mounting arrangement 100 within a vehicle suspension system 102. The system 102 includes an extension portion or a mounting tower that is comprised of a base plate 104 that extends in a longitudinal direction, a pair of arms 106 that extend upwardly from one end of the base plate 104 toward a vehicle frame 108, an adapter plate 110 supported by the pair of arms 106, and an elastomeric bumper such as a windup stop 112. Loading the suspension system 102 biases the spring 32, which moves a portion of the spring 32 within the housing assembly 34. Concentrated loads acting directly on the spring 32 in a conventional setup may cause the spring to shear or otherwise fail. The disclosed embodiment in FIG. 4 could have the windup stop 112 contact the vehicle frame 108, which could comprise a frame rail, chassis member, or other frame structure, directly under severe windup loading. This would bypass the need to have spring 32 react to the concentrated higher loads. Limiting the movement of the spring 32 under such loading conditions can help reduce the concentrated max shear load within the spring 32.

As such, the arms 106 of the mounting tower provide a parallel load path to react to windup loading. Under sever windup loading forces react partially through the spring 32 and partially through the extension portion, i.e. arms 106, via contact of the windup stop 112 against the vehicle frame 108. This significantly reduces shear stresses experienced by the spring 32.

As shown in FIG. 4, the spring 32 includes a first spring end 114 that is pivotally connected to the vehicle frame 108 with a first pivot bracket 116 and a second spring end 118 that is pivotally connected to the vehicle frame 108 with a second pivot bracket 120. Other types of mount configurations could be used for the first 114 and second 118 spring ends. The center portion 70 of the spring 32 is supported on an upper surface 122 of an axle beam 124. The axle beam 124 in the example shown comprises a non-drive steer axle; however, the suspension system 102 and spring mount configuration could be used with other types of axles. The spring 32 is sandwiched between the upper 36 and lower 38 housings, with the lower housing 38 resting on top of the base plate 104 of the mounting tower. A u-bolt assembly 126 is used to secure the spring 32, housing assembly 34 and mounting tower to the axle beam 124; however other mounting structures could also be used. A shock absorber 128 provides additional damping and is secured to the vehicle frame 108 and to a suspension bracket that is secured to the axle beam 124.

The base plate 104 of the mounting tower is rigidly attached to the axle beam 124 as part of a clamp group structure. The base plate 104 can be positioned either above or below the spring 32. The arms 106 first extend from the base plate 104 along each of the laterally opposed side edges 44 of the spring 32 and then extend upwardly to support the adapter plate 110 at a position that is vertically above the upper surface 40 of the spring 32. The windup stop 112 is thus positioned to engage a bottom surface of the vehicle frame 108 to define the stop position.

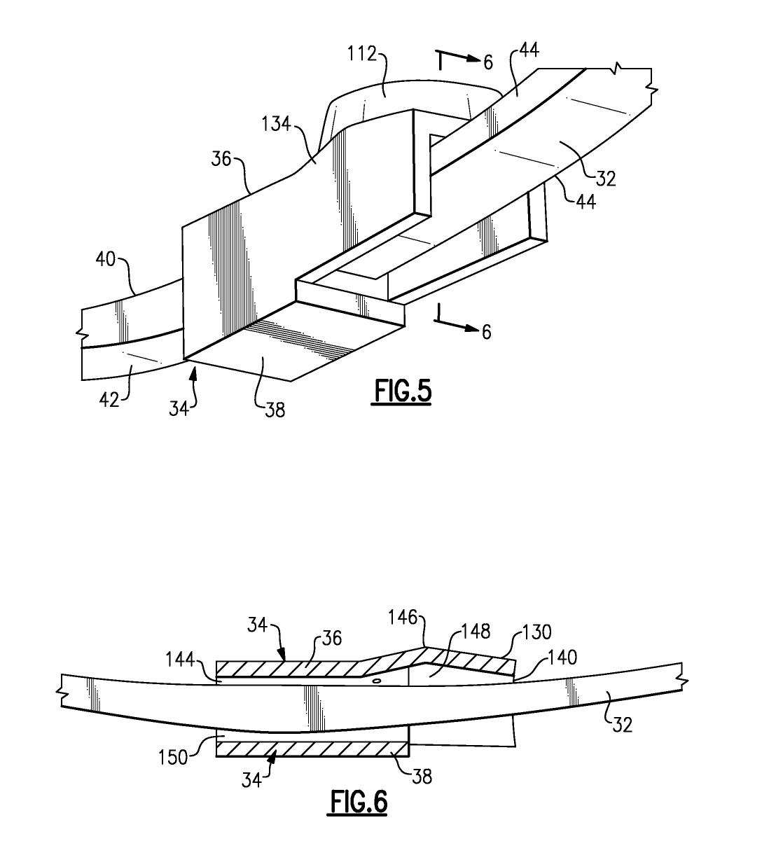

One example of a modified housing assembly 34 is shown in FIG. 5. In this example the windup stop 112 is supported by the upper housing 36. An extension portion 130 extends longitudinally from one of the first 60 and second 62 ends of the upper housing 36. The extension portion 130 has C or U-shaped cross-section such that the extension portion 130 surrounds the upper surface 40 and the opposing lateral side edges 44 of the spring 32. The extension portion 130 does not overlap the lower housing 38 in a vertical direction, and as such, the lower surface 42 of the spring underneath the extension portion 130 is uncovered as indicated at 132.

The windup stop 112 is located on an upper surface 134 of the extension portion 130. Optionally, the windup stop could be mounted to the vehicle frame 108 at a position directly above the extension portion 130. Under certain loading conditions, such as during a windup event, the contact occurs against the windup stop 112 to limit the amount of vertical movement and angular twisting of the suspension. A free end of the extension portion 130 engages the windup stop at full jounce travel of the suspension, which eliminates the need for conventional bump stops above the axle centerline.

The cross sectional view of FIG. 6 illustrates a clearance 140 between an inner surface 142 of the extension portion 130 and the upper surface 40 of the spring 32. In this example, an upper lining 144 does not extend into the extension portion 130. Further, the extension portion 130 includes an angled surface portion 146 that provides for an increased internal area 148 to provide additional clearance as well as a way to adjust a contact angle during a windup stop. By changing the slope or shape of the angled surface portion 146 the contact area for the stop can be adjusted to conform to different suspension configurations.

A lower lining 150 is positioned within the housing assembly 34 to extend to an edge of the lower housing 38. The lower lining 150 does not extend beyond this edge. However, the sectioned lining configuration shown in FIG. 2A, or the reduced center lining configuration shown in FIG. 2B could also be used.

In addition to distributing loads, the extension portion 130 can provide a mounting location for suspension components such as the windup stop 112 or shock absorber. As such, incorporating the extension portion 130 into the suspension system 102 may eliminate the need for separate suspension components such as the mounting tower and the adapter plate 110. Also, the extension portion 106 or 130 can provide the same functionality of a conventional bump stop (ounce bumper) that would be mounted above the axle centerline and allow for reduction of components, weight and cost associated to the conventional bump stop.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A suspension spring mount comprising:
a spring defining a longitudinal axis;
a housing surrounding a portion of said spring, said housing having a housing inner portion positioned between first and second housing end portions; and
a lining securing said spring to said housing, wherein a portion of said lining at said first and said second housing end portions is thicker than a portion of said lining at said housing inner portion.

2. The suspension spring mount according to claim 1 wherein said lining has a variable thickness to provide variable compression force along a length of the lining.

3. The suspension spring mount according to claim 1 wherein said housing includes an upper housing portion that surrounds an upper surface and opposing side edges of said spring and a lower housing portion that surrounds a lower surface of said spring, and wherein said lining comprises a plurality of discrete lining portions including at least a first lining portion positioned between a first end of said upper housing portion and said upper surface of said spring and a second lining portion positioned between a second end of said upper housing portion and said upper surface of said spring, and wherein said first and said second lining portions are longitudinally spaced apart from each other by a gap.

4. The suspension spring mount according to claim 3 wherein said plurality of discrete lining portions includes a third lining portion positioned between a first end of said lower housing portion and said lower surface of said spring and a fourth lining portion positioned between a second end of said lower housing portion and said lower surface of said spring, and wherein said third and said fourth lining portions are longitudinally spaced apart from each other by a gap.

5. The suspension spring mount according to claim 3 wherein a longitudinal length of said gap is greater than a longitudinal length of either said first lining portion or said second lining portion.

6. The suspension spring mount according to claim 1 wherein said spring is made from a composite material and wherein said lining is made from an elastomeric material.

7. The suspension spring mount according to claim 1 wherein said spring has a first spring end adapted for pivotal attachment to a vehicle frame, a second spring end adapted for pivotal attachment to the vehicle frame, and a center portion that that is supported by an axle, said center portion being surrounded by said housing, with said housing being positioned on an upper surface of said axle.

8. The suspension spring mount according to claim 1 wherein said housing includes an upper housing portion that surrounds an upper surface and opposing side edges of said spring and a lower housing portion that surrounds a lower surface of said spring, and wherein said upper housing portion includes a longitudinal extension that extends outwardly from one of said first and said second housing end portions such that said longitudinal extension does not overlap said lower housing portion.

9. The suspension spring mount according to claim 8 wherein said longitudinal extension is C-shaped such that said longitudinal extension surrounds said upper surface and said opposing side edges of said spring.

10. The suspension spring mount according to claim 8 including a windup bumper positioned above an upper surface of said longitudinal extension.

11. The suspension spring mount according to claim 10 wherein said windup bumper comprises a jounce bumper.

12. The suspension spring mount according to claim 8 including a clearance gap formed between an upper surface of said spring and a lower surface of said longitudinal extension, and wherein said lining is bonded to said spring within said housing such that said lining does not extend into said clearance gap.

13. The suspension spring mount according to claim 12 wherein a vertical height of said clearance gap varies along a longitudinal length of said clearance gap.

14. The suspension spring mount according to claim 1 including a bumper plate positioned between a lower surface of said housing and an upper surface of an axle, said bumper plate including a pair of longitudinally extending arms positioned to extend along opposing lateral sides of said spring, a mounting tower extending vertically upward from said pair of longitudinally extending arms, an adaptor plate supported by said mounting tower, and a bumper supported by said adaptor plate.

15. A suspension spring mount comprising:
a spring made from a composite material and defining a longitudinal axis, said spring being movable between a biased position and an unbiased position;
a housing surrounding a portion of said spring, said housing having a housing inner portion positioned between first and second housing end portions;
an extension extending from one of said first and said second housing end portions, wherein said extension limits movement of said housing relative to a vehicle frame structure during windup events; and
a lining securing said spring to said housing wherein a clearance gap is provided within said housing at least between one inner surface of said housing inner portion and at least one outer surface of said spring.

16. The suspension spring mount of claim 15 wherein a free end of said extension engages a windup stop under a high brake torque load.

17. The suspension spring mount of claim 15, wherein at least one of said extension and the vehicle frame structure includes an elastomeric component for contacting the other of said extension and the vehicle frame structure.

18. The suspension spring mount of claim 15, wherein said extension contacts the vehicle frame structure when said spring moves to said biased position.

19. The suspension spring mount of claim 15 wherein said extension contacts said spring when moving to said biased position, and wherein said housing is rigidly connected to an axle with a free end of said extension extending longitudinally beyond said axle such that said free end engages a windup stop under high brake torques, and wherein said free end is positioned for controlling a proper full jounce travel of a vehicle suspension.
